(19) United States
(12) Patent Application Publication
(10) Pub. No.: US 2009/0050177 A1
(43) Pub. Date: Feb. 26, 2009

(54) Substrate cleaning method and substrate cleaning apparatus

(76) Inventors: Hiroshi Nagayasu, Fukuoka-ken (JP); Norio Miyamoto, Kumamoto-Ken (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 11/887,001

(22) PCT Filed: Feb. 28, 2006
(86) PCT No.: PCT/JP2006/303691

§ 371 Date: Sep. 24, 2007

(30) Foreign Application Priority Data
Mar. 29, 2005 (JP) 2005-093435

(51) Int. Cl. B08B 1/00; B08B 13/00

(52) U.S. Cl. 134/6; 134/104.1

(57) ABSTRACT

The present invention provides a substrate cleaning method which is intended to securely remove matters attached to the periphery of a substrate to be processed and enhance the yield of products as well as intended to lengthen the life of the apparatus. This substrate cleaning method comprises the steps of: cleaning the periphery of a substrate by contacting a periphery cleaning member 10 with the periphery of the substrate W; and removing matters from the periphery cleaning member, the matters once attached to the substrate and then transferred therefrom and attached to the periphery cleaning member. The step of cleaning the periphery using the periphery cleaning member and the step of removing the attached matters from the periphery cleaning member are performed at the same time.

### TECHNICAL FIELD

The present invention relates to a substrate cleaning method and a substrate cleaning apparatus for cleaning a substrate, such as a semiconductor wafer, and particularly to a substrate cleaning method and a substrate cleaning apparatus for cleaning a periphery of the substrate to be processed.

### BACKGROUND ART

In the past, a cleaning method (apparatus) is known as a cleaning technology of the type described above, which method is adapted for cleaning the periphery of a semiconductor wafer (hereinafter, merely referred to as a wafer) by contacting a periphery cleaning member with the periphery of the wafer while rotating the wafer and supplying a cleaning liquid on its surface (for example, see the Japanese Patent Laid-Open Publication No. 2003-16396 (especially, claims and FIGS. 2 and 3)).

In this cleaning method (apparatus), the periphery cleaning member is configured such that it can be moved vertically relative to a wafer while rotating in contact with the periphery of the wafer. Such movement of the periphery cleaning member can remove matters, such as particles and a chemical liquid, attached to the periphery of the wafer.

In such a cleaning method (apparatus), however, since the periphery cleaning member is rotated and moved in up-and-down direction while being in contact with the periphery of a wafer, the matters, such as particles and a chemical liquid, once removed from the periphery of the wafer may be attached to or remain on the cleaning member and tend to be attached again to the wafer. In addition, due to the attached matters remaining on the cleaning member, the life of the cleaning member and even the life of the apparatus itself may be decreased.

### DISCLOSURE OF THE INVENTION

The present invention was made in light of the above problem, and it is therefore an object of this invention to provide a substrate cleaning method and a substrate cleaning apparatus which are intended to enhance the yield of products by securely removing matters attached to the periphery of a substrate to be processed as well as to lengthen the life of the apparatus.

The substrate cleaning method according to the present invention is a method for cleaning a periphery of a substrate to be processed, comprising the steps of: cleaning the periphery of the substrate by contacting a periphery cleaning member with the periphery of the substrate; and removing matters from the periphery cleaning member, the matters once attached to the substrate to be processed and then transferred therefrom and attached to the periphery cleaning member; wherein the step of cleaning the periphery using the periphery cleaning member and the step of removing the attached matters from the periphery cleaning member are performed at the same time.

According to the substrate cleaning method of this invention, reattachment of the matters once removed from a substrate to be processed, onto the same substrate can be prevented, thus removing securely the attached matters from the substrate. Accordingly, the cleaning accuracy can be enhanced and the yield of products can be improved. Since contamination of the periphery cleaning member can be prevented, the life of the periphery cleaning member can be lengthened, and hence the life of the substrate cleaning apparatus itself can be extended.

In the substrate cleaning method according to the present invention, the periphery cleaning member, which is in contact with the substrate to be processed, may be pressed against the substrate. With such a substrate cleaning method, the attached matters can be removed more securely from the substrate to be processed. Consequently, the cleaning accuracy can be further improved, and the yield of products can be further enhanced. In this case, the periphery cleaning member may be pressed against the substrate, for example, by dilating a flexible tube, such as by supplying a fluid into the flexible tube disposed in the periphery cleaning member. According to this substrate cleaning method, the periphery cleaning member can be pressed against the substrate to be processed by a simple measure.

In the substrate cleaning method according to the present invention, the substrate and the periphery cleaning member may be rotated such that their respective portions which are in contact with each other are moved in opposite directions while facing relative to each other at a point where the substrate and the periphery cleaning member contact with each other. With such a substrate cleaning method, the attached matters can be removed more securely from the substrate to be processed. Therefore, the cleaning accuracy can be further improved, and the yield of products can be further enhanced.

In the substrate cleaning method according to the present invention, the periphery cleaning member, which is in contact with the substrate, may be shifted in the substantially orthogonal direction relative to a plate surface of the substrate. By employing this substrate cleaning method, local wear of the periphery cleaning member can be prevented. Thus, the life of the periphery cleaning member can be lengthened, and hence the life of the substrate apparatus itself can be extended.

In the substrate cleaning method according to the present invention, two periphery cleaning members may be driven to be in contact with the peripheral of the substrate at opposite portions of the peripheral, respectively. With such a cleaning method, the contact area between the substrate and the periphery cleaning member can be increased, thereby to remove the attached matters from the substrate more efficiently as well as to remove the matters from the substrate more securely. Consequently, the cleaning accuracy can be further enhanced, and the yield of products can be more improved.

In the substrate cleaning method according to the present invention, a pair of periphery cleaning members arranged to be in contact with each other may be driven to be in contact with the substrate while being rotated in reverse directions, respectively. With this substrate cleaning method, the contact area between the substrate and the periphery cleaning members can be significantly increased, as such the attached matter can be removed from the substrate to be processed more securely and efficiently. In addition, by causing the pair of periphery cleaning members to be compressed against each other, the attached matters present in the periphery cleaning members can be excluded outside. Consequently, the cleaning accuracy can be further enhanced and the yield of products can be further improved. Additionally, the life of the periphery cleaning members can be lengthened, and the life of the substrate cleaning apparatus itself can also be elongated. In this case, the pair of periphery cleaning members may be driven to be in contact with the substrate such that each rotation axis of the pair of periphery cleaning members and the perpendicular line drawn to a plate surface of the substrate to be cleaned are parallel to one another.

In the substrate cleaning method according to the present invention, the attached matters may be removed from the periphery cleaning member by jetting a cleaning liquid toward the periphery cleaning member. With such a substrate cleaning method, the attached matters can be removed from the periphery cleaning member more securely. Consequently, the cleaning accuracy for the substrate to be processed can be further enhanced and the yield of products for the substrate can be further improved. In addition, the life of the periphery cleaning member can be lengthened, and the life of the substrate cleaning apparatus itself can be extended.

Alternatively, in the substrate cleaning method according to the present invention, the attached matters may be removed from the periphery cleaning member by compressing the periphery cleaning member as well as by jetting a cleaning liquid toward the periphery cleaning member. By employing such a substrate cleaning method, the attached matters can be removed more securely from the periphery cleaning member. Thus, the cleaning accuracy for the substrate to be cleaned can be further enhanced, and the yield of products for the substrate can be more improved. Furthermore, the life of the periphery cleaning member can be elongated, and the life of the substrate cleaning apparatus itself can also be lengthened.

In the substrate cleaning method according to the present invention, the attached matters may be removed from the periphery cleaning member by supplying a cleaning liquid into the periphery cleaning member formed of a porous material and then causing the cleaning liquid to flow out of the periphery cleaning member. With this substrate cleaning method, the attached matters can be removed more securely from the periphery cleaning member. Consequently, the cleaning accuracy for the substrate to be processed can be further enhanced and the yield of products for the substrate can be more improved. In addition, the life of the cleaning member can be elongated, and the life of the substrate cleaning apparatus itself can also be lengthened. Alternatively, in this case, the periphery cleaning member may be compressed intermittently with its rotation. By employing such a substrate cleaning method, the attached matters present in the periphery cleaning member can be excluded outside. Consequently, the cleaning accuracy can be further enhanced and the yield of products can be more improved. Moreover, the life of the periphery cleaning member can be lengthened, and the life of the substrate cleaning apparatus itself can also be extended.

The substrate cleaning apparatus according to the present invention is an apparatus for cleaning a periphery of a substrate to be processed, comprising: a first cleaner including a rotatable periphery cleaning member which is adapted to be in contact with the periphery of the substrate and remove matters attached to the substrate from its periphery; and a second cleaner which is configured to remove the matters, once attached to the substrate and then transferred from the substrate to the periphery cleaning member, from the periphery cleaning member while removing the matters attached to the substrate by using the first cleaner.

With the substrate cleaning apparatus according to the present invention, reattachment of the attached matters once removed from the substrate to be processed, onto the substrate can be prevented, thus the attached matters can be removed more securely from the substrate to be processed. Consequently, the cleaning accuracy can be more enhanced and the yield of products can be further improved. In addition, since contamination of the periphery cleaning member can be prevented, the life of the periphery cleaning member can be lengthened, and the life of the substrate cleaning apparatus itself can also be extended.

In the substrate cleaning apparatus according to the present invention, the first cleaner may further include a pressing mechanism adapted to press the periphery cleaning member against the substrate. With this substrate cleaning apparatus, the attached matters can be removed more securely from the substrate to be processed. Consequently, the cleaning accuracy can be further enhanced and the yield of products can be more improved. Alternatively, in this case, the pressing mechanism may include a flexible tube disposed in the periphery cleaning member and a fluid supply source for supplying a fluid into the flexible tube. By employing such a substrate cleaning apparatus, the periphery cleaning member can be pressed against the substrate to be processed, with a simple construction.

In the substrate cleaning apparatus according to the present invention, the first cleaner may further include a shifting mechanism adapted to shift the periphery cleaning member, which is in contact with the substrate, in the direction along the rotation axis of the periphery cleaning member, relative to the substrate. With such a substrate cleaning apparatus, the attached matters can be removed more securely from the substrate to be processed. Thus, the cleaning accuracy can be further enhanced and the yield of products can be more improved.

In the substrate cleaning apparatus according to the present invention, the first cleaner may include two periphery cleaning members adapted to be in contact with the peripheral of the substrate at opposite portions of the peripheral, respectively. By employing this substrate cleaning apparatus, the contact area between the substrate to be processed and the periphery cleaning member can be increased, thereby to remove the attached matters more efficiently from the substrate to be processed as well as to remove the attached matters more securely from the substrate to be processed. Consequently, the cleaning accuracy can be further enhanced and the yield of products can be more improved.

In the substrate cleaning apparatus according to the present invention, the first cleaner may include a pair of periphery cleaning members which are arranged to be in contact with each other and rotatable in reverse directions relative to each other. With such a substrate cleaning member, the contact area between the substrate to be processed and the periphery cleaning members can be significantly increased, thereby to remove the attached matters from the substrate to be processed more securely and efficiently. In addition, by causing the pair of periphery cleaning members to be compressed against each other, the attached matters present in the periphery cleaning members can be excluded outside. Consequently, the cleaning accuracy can be further enhanced and the yield of products can be further improved. Additionally, the life of the periphery cleaning members can be further lengthened, and the life of the substrate cleaning apparatus itself can also be more elongated. In this case, the pair of periphery cleaning members may be configured to be in contact with the substrate such that each rotation axis of the pair of periphery cleaning members and the perpendicular line drawn to a plate surface of the substrate are parallel to one another.

In the substrate cleaning apparatus according to the present invention, the second cleaner may include a nozzle adapted to jet a cleaning liquid toward the periphery cleaning member. With this substrate cleaning apparatus, the attached matters can be removed from the periphery cleaning member more securely. Consequently, the cleaning accuracy for the substrate to be processed can be further enhanced and the yield of products for the substrate can be further improved. In addition, the life of the periphery cleaning member can be further lengthened, and the life of the substrate cleaning apparatus itself can also be more extended. Alternatively, in this case, the second cleaner may further include a cam adapted to press the periphery cleaning member. By employing such a substrate cleaning apparatus, the attached matters can be removed more securely from the periphery cleaning member by compressing the periphery cleaning member. Consequently, the cleaning accuracy for the substrate to be processed can be further enhanced and the yield of products for the substrate can be more improved. In addition, the life of the periphery cleaning member can be more lengthened, and the life of the substrate cleaning apparatus itself can be further extended.

In the substrate cleaning apparatus according to the present invention, the periphery cleaning member may be formed of a porous material, and the second cleaner may include a cleaning liquid supply source for supplying a cleaning liquid into the periphery cleaning member formed of the porous material. With this substrate cleaning apparatus, the attached matters can be removed more securely from the periphery cleaning member, due to the cleaning liquid which flows out of the periphery cleaning member. Consequently, the cleaning accuracy for the substrate to be processed can be further enhanced and the yield of products for the substrate can be more improved. Additionally, the life of the periphery cleaning member can be more lengthened, and the life of the substrate cleaning apparatus itself can be further extended. Alternatively, in this case, the periphery cleaning member formed of the porous material is configured to be compressed intermittently with its rotation. By employing such a substrate cleaning apparatus, the matters present in the periphery cleaning member can be excluded outside. Thus, the cleaning accuracy for the substrate to be processed can be further enhanced and the yield of products for the substrate can be more improved. Additionally, the life of the periphery cleaning member can be more elongated, and the life of the substrate cleaning apparatus itself can be further extended.

### BRIEF DESCRIPTION OF THE DRAWINGS

FIG. 1 is a schematic perspective view showing a substantial part of one embodiment of a substrate cleaning method and a substrate cleaning apparatus according to the present invention.

FIG. 2 is a schematic plan view showing a substantial part of the substrate cleaning method and the substrate cleaning apparatus shown in FIG. 1.

FIG. 3 is a schematic cross section showing a substantial part of the substrate cleaning method and the substrate cleaning apparatus shown in FIG. 1.

FIG. 4 is a schematic plan view showing a pressing mechanism of a first cleaner.

FIG. 5 is a schematic plan view showing a rotation drive mechanism of the first cleaner.

FIG. 6 is a schematic side view showing a second cleaner.

FIG. 7 is a schematic side view showing a shifting mechanism of the first cleaner.

FIG. 8 is a perspective view showing one example of a periphery cleaning member of the first cleaner.

FIG. 9 is a perspective view showing another example of a periphery cleaning member of the first cleaner.

FIG. 10 is a schematic side view showing a variation of the first cleaner.

FIG. 11 is a schematic plan view showing another variation of the first cleaner.

FIG. 12 is a schematic side view showing still another variation of the first cleaner.

FIG. 13 is a schematic cross section showing a variation of the pressing mechanism.

FIG. 14 is a schematic plan view showing a variation of the second cleaner.

FIG. 15 is a schematic cross section showing still another variation for the first cleaner and the second cleaner.

### MODE FOR CARRYING OUT THE INVENTION

Hereinafter, one embodiment of the present invention will be described with reference to the attached drawings. In the description provided below, a substrate cleaning apparatus and a substrate cleaning method according to the present invention will be discussed about an example which is applied to a cleaning process of a semiconductor wafer having a disk-like shape.

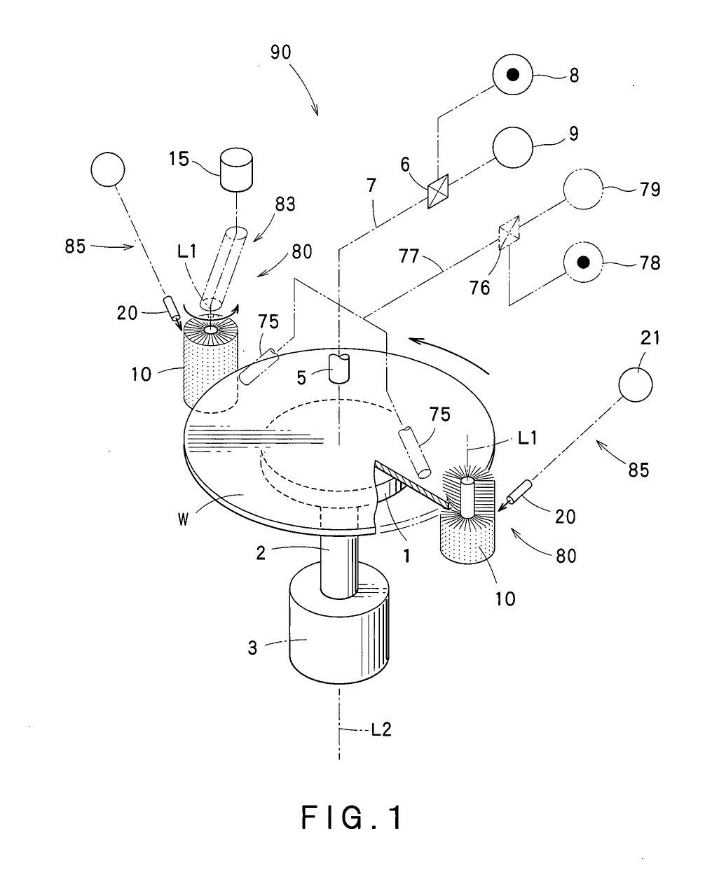

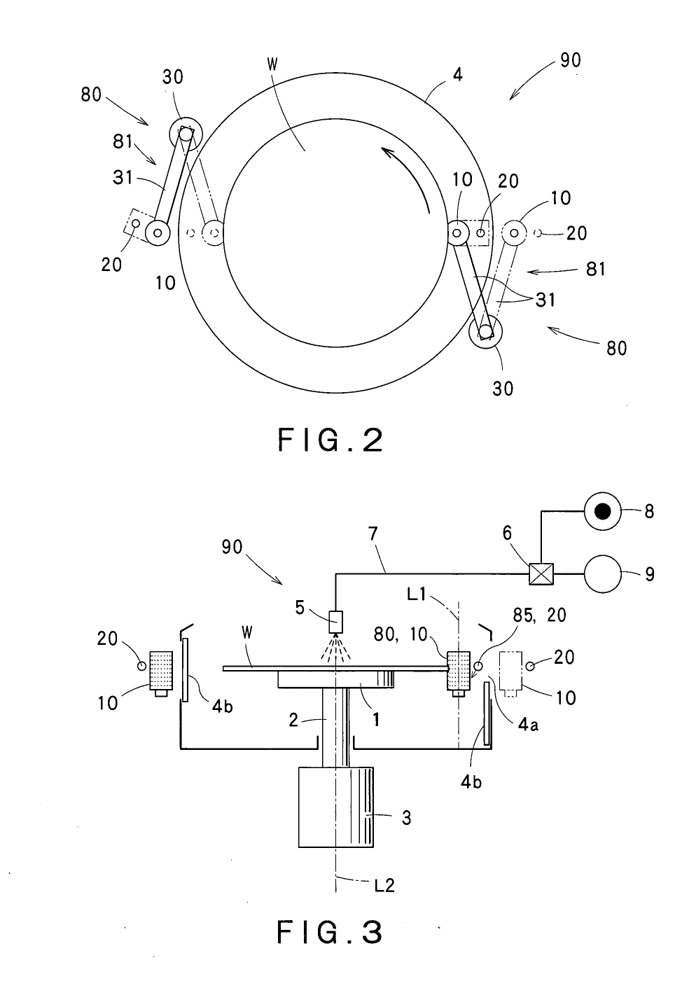

FIG. 1 is a schematic perspective view showing a key portion of one embodiment of a substrate cleaning method and a substrate cleaning apparatus according to the present invention, FIG. 2 is a schematic plan view showing a key portion of the substrate cleaning method and the substrate cleaning apparatus shown in FIG. 1, and FIG. 3 is a schematic cross section showing a key portion of the substrate cleaning method and the substrate cleaning apparatus shown in FIG. 1.

As shown in FIGS. 1 to 3, a substrate cleaning apparatus 90 comprises a rotatable spin chuck 1 adapted to suck and hold a semiconductor wafer (hereinafter, also referred to as “a wafer”) W, which is a substrate to be processed, in a horizontal state, a motor 3 which is connected with the rotation shaft 2 of the spin chuck 1 and adapted to rotate the spin chuck together with the wafer about a vertical rotation axis L2, a cup 4 (see FIG. 3) surrounding the bottom and side faces of the wafer W, a cleaning liquid supply nozzle 5 which is adapted to move above the wafer W held by the spin chuck 1 and supply a cleaning liquid (chemical liquid or pure water) onto the surface of the wafer W, a first cleaner 80 having a periphery cleaning member 10 which is configured to contact with the periphery of the wafer W so as to remove matters, such as particles and a cleaning liquid, attached to the periphery of the wafer W, and a second cleaner 85 adapted to remove matters from the periphery cleaning member 10, which matters was once attached to the wafer W and then transferred therefrom and attached to the periphery cleaning member 10 during the removal of the matters attached to the wafer W by using the first cleaner 80. As shown in FIGS. 1 and 3, the cleaning liquid supply nozzle 5 is switchably connected with a chemical liquid supply source 8 and a pure water supply source 9 for supplying pure water as a rinsing liquid, via a supply tube 7, in the course of which a switching valve 6 is provided. At the side wall of the cup 4, openings 4a each adapted to make the interior of the cup 4 communicate with the exterior thereof and shutters 4b adapted to open and close the openings 4a are provided.

First, mainly referring to FIGS. 1 to 5, the first cleaner 80 will be described in more detail.

As shown in FIG. 2, the first cleaner 80 further includes a position switching mechanism 81 which causes the periphery cleaning member 10 to move between a cleaning position in which the periphery cleaning member 10 is in contact with the periphery of a wafer W and a waiting position external to the cup 4. The position switching mechanism 81 includes a movable arm 31 adapted to support the periphery cleaning member 10, and a position switching motor 30 which is connected with an end of the movable arm 31 and adapted to sway the movable arm 31. When the position switching motor 30 is driven so as to sway the movable arm 31, the periphery cleaning member 10 is moved between its cleaning position and its waiting position via one of the openings 4a provided in the side wall of the cup 4.

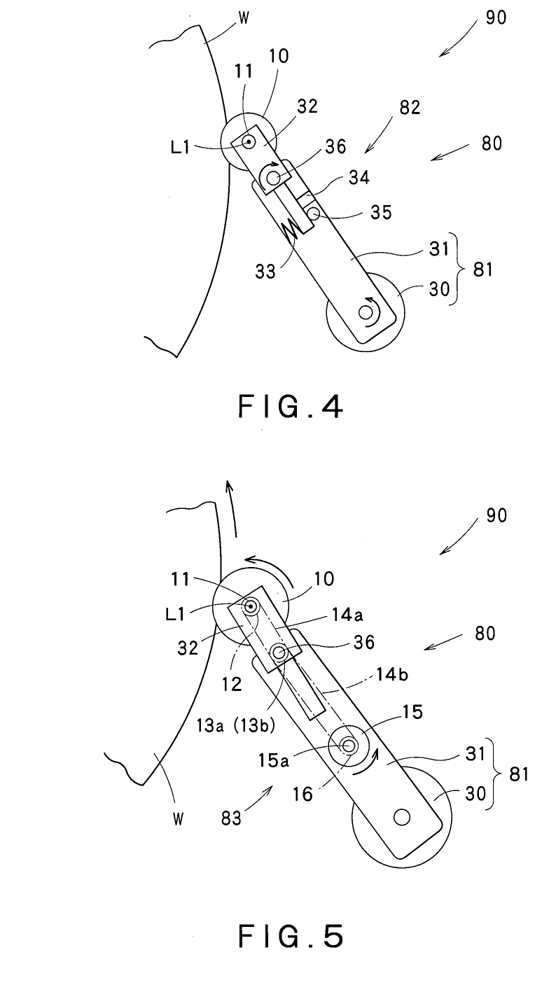

As shown in FIG. 4, at one end of the movable arm 31, which is spaced away from the position switching motor 30, a swaying arm 32 is provided. The swaying arm 32 is connected so as to be turnable, at its central portion, with the movable arm 32 via a shaft 36. The periphery cleaning member 10 is rotatably connected, about a rotation axis L1, with one end portion of the swaying arm 32 via a shaft 11.

Also, as shown in FIG. 4, the first cleaner 80 further includes a pressing mechanism 82 which is adapted to press the periphery cleaning member 10 against the wafer W. The pressing mechanism 82 includes a press spring 33 which is provided in movable arm 31 such that it is opposed to the other end portion of the swaying arm 32. The press spring 33 presses and biases the swaying arm 32 to sway. In the movable arm 31, a pressure sensor 34 is provided on the opposite side relative to the press spring 33 across the swaying arm 32. The pressure sensor 34 is in contact with the swaying arm 32 which is biased to sway due to the press spring 33, so as to detect the biasing force exerted from the press spring 33. In this embodiment, the contact pressure (pressing force) of the periphery cleaning member 10 against the periphery of the wafer W can be adjusted by using the press spring 33 and the pressure sensor 34.

Additionally, as shown in FIG. 4, a stopper 35 is provided in the movable arm 32 on the opposite side relative to the press spring 33 across the swaying arm 32. The swaying range of the swaying arm 32 can be controlled by using the stopper 35.

Moreover, as shown in FIG. 5, the first cleaner 80 includes a rotation drive section (rotation drive part) 83 which is adapted to drive the periphery cleaning member 10 to rotate. The rotation drive section 83 has a rotating motor 15 disposed on the movable arm 31, which motor 15 serves as a driving means adapted to drive the periphery cleaning member 10 to rotate. As shown in FIG. 5, a drive sprocket 16 is attached to the drive shaft 15a of the rotating motor 15. A driven sprocket 12 is attached to the shaft 11 which connects the periphery cleaning member 10 with the swaying arm 32. Further, a first intermediate sprocket 13a and a second intermediate sprocket 13b are attached to a shaft 36 which connects the swaying arm 32 with the movable arm 31. A first timing belt 14a is provided across the driven sprocket 12 and the first intermediate sprocket 13a, and a second timing belt 14b is arranged across the second intermediate sprocket 13b and the drive sprocket 16. With such configuration, when the rotating motor 15 is driven, the periphery cleaning member 10 is rotated together with the rotation of the rotating motor 15, in the same direction as the rotating direction (e.g., the counter-clockwise direction in FIG. 5) of the rotating motor 15.

As described above, the spin chuck 1 causes the wafer W to rotate, with the wafer W being sucked and held by the spin chuck 1. At this time, it is preferred that the wafer W is rotated such that, in a position where the wafer W is in contact with the periphery cleaning member 10, the portions which are in contact with each other are moved in the opposite directions. In this embodiment, the rotation axis L2 of the wafer W and the rotation axis L1 of the periphery cleaning member 10 extend substantially in parallel with each other (see FIGS. 1 and 2), wherein the wafer W is rotated in the same direction (e.g., the counter-clockwise direction in FIG. 5) as the rotating direction of the periphery cleaning member 10. Accordingly, the wafer W and the periphery cleaning member 10 can be rotated such that the periphery of the wafer W and the periphery of the periphery cleaning member 10 are moved in a such direction that they can face each other in a position where the wafer W and the periphery cleaning member 10 contact with each other. By rotating the wafer W and the periphery cleaning member 10 in such a manner, the wafer W and the cleaning member 10 can be contacted with each other, securely, with some pressure. Thus, matters attached to the periphery of the wafer W, such as particles and/or a chemical liquid, can be securely removed.

As shown in FIG. 1, in this embodiment, the periphery cleaning member 10 has a substantially cylindrical contour. The periphery cleaning member 10 comprises a brush or is formed of a porous material, such as sponge, which is a flexible and compressible material.

As shown in FIGS. 1 to 3, in this embodiment, the first cleaner 80 as described above includes two periphery cleaning members 10, 10. Two periphery cleaning members 10, 10 contact with the peripheral of a wafer W at opposite portions of the peripheral of the wafer W. By driving such a plurality of periphery cleaning members 10 so as to be in contact with opposed peripheral portions of the wafer W, it is possible to create uniform force to act on the wafer W, with the force directed toward the center of rotation of the wafer W, thereby achieving the cleaning of wafer W in a significantly stable state.

Next, mainly referring to FIGS. 1 to 3 and 6, the second cleaner 85 will be described in detail.

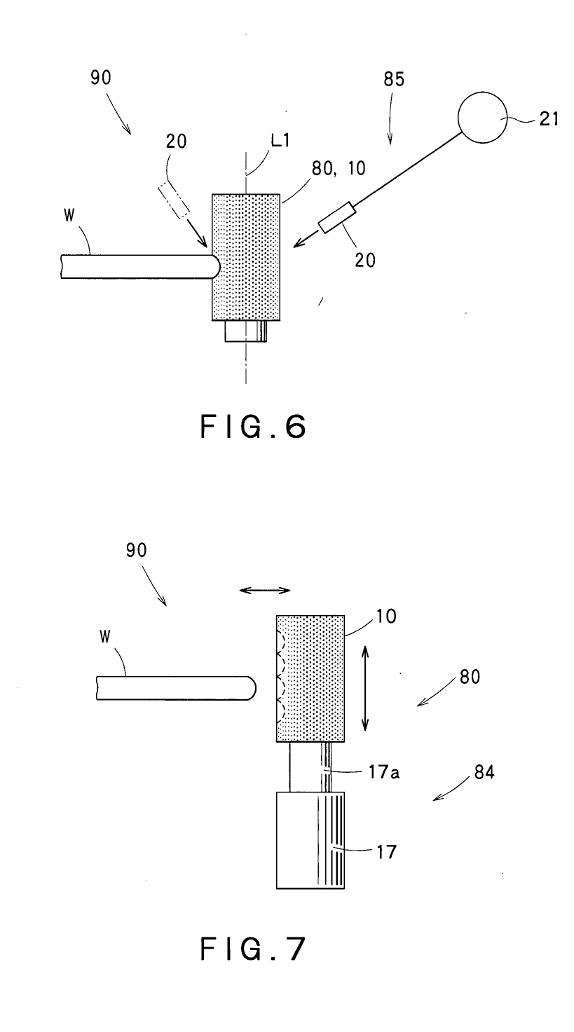

As shown in FIGS. 1 and 6, the second cleaner 85 includes a nozzle 20 adapted to jet (inject, spout) a cleaning liquid toward each periphery cleaning member 10, and a cleaning liquid supply source 21 which supplies a cleaning liquid to the nozzle 20. When a cleaning liquid is jetted from the nozzle 20 toward a back side of the periphery cleaning member 10, i.e., a side of the periphery cleaning member 10, which does not face the wafer W, as shown in FIG. 6, for example, matters, which was transferred from the wafer W and attached to the periphery cleaning member 10 during removal of the matters attached to the wafer W, can be readily removed from the periphery cleaning member 10. Namely, the matters once attached to the wafer W and then transferred therefrom and attached to the periphery cleaning member 10 can be removed due to the jetted cleaning liquid, before the matters would be again in contact with the wafer W with rotation of the periphery cleaning member 10.

In this embodiment, pure water is employed as the cleaning liquid, which is supplied from the cleaning liquid supply source 21 and jetted from the nozzle 20. The cleaning liquid supply source 21 and the nozzle 20 are connected with each other via a flexible tube (not shown). In this embodiment, as simply shown in FIGS. 2 and 3, each nozzle 20 is supported by the swaying arm 32, for example, and is configured such that it can be moved together with the periphery cleaning member 10 between the cleaning position and the waiting position. Thus, the relative positional relationship between the nozzle 20 and the periphery cleaning member 10 can be maintained between the cleaning position and the waiting position.

It should be appreciated that the direction of jetting the cleaning liquid toward the periphery cleaning member 10 from the nozzle 20 is not limited to the example described above. For example, as shown by two-dot chain lines in FIG. 6, the cleaning liquid may be jetted toward the contact portion between the periphery cleaning member 10 and the wafer W, in a direction defined from the center of the wafer W to its outside. Alternatively, both of the nozzle adapted to jet a cleaning liquid toward a back side of the periphery cleaning member 10 and the nozzle adapted to jet the cleaning liquid toward the contact portion between the periphery cleaning member 10 and the wafer W from the side of the center of wafer W may be used together. The manner of jetting a cleaning liquid due to the nozzle 20 may be shower, or otherwise, of the two-fluid nozzle type, in which jetting is carried out while mixing the cleaning liquid and air, and other well known methods can also be utilized.

The method of cleaning a wafer W using the substrate cleaning apparatus 90 which is configured as described above will be discussed.

First, matters, such as particles, attached to the surface of a wafer W are removed by supplying or discharging a chemical liquid toward approximately the center of the rotating wafer W from the cleaning liquid supply nozzle 5. The chemical liquid supplied is spread over the entire surface of the wafer W, thereby cleaning the wafer W due to the chemical liquid.

Subsequently, after switch of the switching valve 6, the chemical liquid, particles and the like, remaining on the surface of the wafer W, are removed by supplying or discharging pure water toward approximately the center of the surface of the wafer W from the cleaning liquid supply nozzle 5. Corresponding to the timing of supplying the pure water, each periphery cleaning member 10 of the first cleaner 80 is moved to the cleaning position so as to be in contact with the side periphery of the wafer W due to drive of the position switching motor 30 of the position switching mechanism 81 of the first cleaner 80. By driving the rotating motor 15 of the rotation drive section 83 of the first cleaner 80, the periphery cleaning member 10 can be rotated such that its surface is moved to face the periphery of the wafer W along the moving direction of the periphery of the wafer W. At this time, the periphery cleaning member 10 is pressed against the wafer W due to the pressing mechanism 82 of the first cleaner 80. In this way, with the contact of the periphery cleaning member 10 against the periphery of the wafer W, matters, such as particles or the like, attached to the periphery of the wafer W can be removed.

Along with such cleaning of the wafer W, a cleaning liquid is jetted to the periphery cleaning member 10 from the nozzle 20 of the second cleaner 85, while the periphery cleaning member 10 is driven so as to remove the matters from the wafer W. Consequently, the matters once removed from the wafer W due to the periphery cleaning member 10 and then transferred or attached to the periphery cleaning member 10 are removed from the periphery cleaning member 10. Namely, reattachment of the matters once transferred and attached to the periphery cleaning member 10 from the wafer W, onto the wafer W due to rotation of the periphery cleaning member 10 can be prevented.

In such a manner, once removing the matters attached to the wafer W, each periphery cleaning member 10 is moved to the waiting position which is away from the wafer W due to drive of the position switching motor 30. The supply of pure water from the cleaning liquid supply nozzle 5 is then stopped. Subsequently, the spin chuck 1 and the wafer W are rotated together by the motor 3 at a high speed, thereby removing or scattering away liquid drops attached to the wafer W so as to dry the wafer W.

According to this embodiment as described above, reattachment of the matters once removed from a wafer W, onto the wafer W can be prevented, and as such the matters attached to the wafer W can be removed from the wafer W more securely. Thus, the accuracy of cleaning can be improved and the yield of products can be enhanced. In addition, since contamination of each periphery cleaning member 10 can be prevented, the life of the periphery cleaning member 10 can be lengthened, thus leading to extension of the life of the substrate cleaning apparatus 90 itself.

Various modifications are possible relative to the above embodiment without departing from the spirit and scope of the present invention. examples of such modifications will be described with reference mainly to FIGS. 7 to 15. In FIGS. 7 to 15, like parts to those in the embodiment shown in FIGS. 1 to 6, or like parts between modifications or alterations described below, will be denoted by like numerals, respectively, and their duplicated details are omitted.

For example, each first cleaner 80 may further include a shifting mechanism 84, which is adapted to shift the position of the periphery cleaning member 10 while the periphery cleaning member 10 is in contact with a wafer W, along the rotation axis L1 of the periphery cleaning member 10, relative to the wafer W. In the example shown in FIG. 7, the shifting mechanism 84 is provided as a lifting cylinder 17 having a piston rod 17a. The piston rod 17a is adapted to rotatably support the periphery cleaning member 10. The lifting cylinder 17 is supported by the aforementioned swaying arm 32, for example. By rendering the contact position of the periphery cleaning member 10 against the wafer W changeable in such a manner, local wear of the periphery cleaning member 10 can be prevented. Accordingly, the life of the periphery cleaning member 10, and hence the life of the substrate cleaning apparatus 90 can be elongated. It should be appreciated that the contact position of the periphery cleaning member 10 against the wafer W may be changed during the cleaning of a sheet of wafer W, or otherwise the contact position of the periphery cleaning member 10 with the wafer W may be changed for each wafer W to be cleaned.

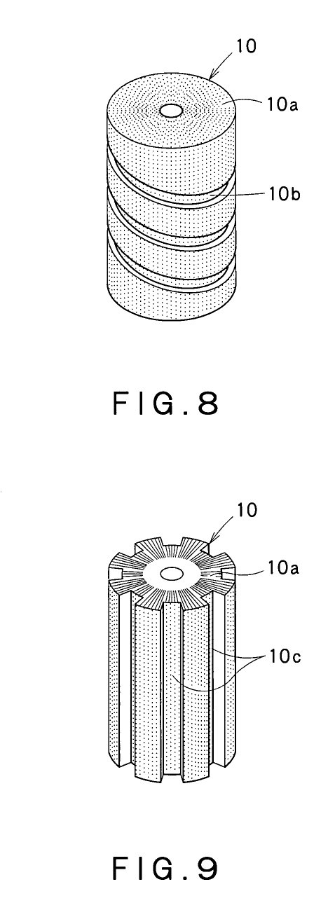

In the embodiment described above, an example in which each periphery cleaning member 10 has a substantially cylindrical contour has been discussed. However, the shape of the periphery cleaning member 10 is not limited to this aspect. For example, as shown in FIGS. 8 and 9, a groove or the like feature may be provided in the outer surface of the periphery cleaning member 10. In the examples shown in FIGS. 8 and 9, the periphery cleaning member 10 has a cylindrical base portion 10a which has a substantially cylindrical contour and comprises a brush or is formed of a porous material, such as sponge. In the example shown in FIG. 8, a spiral groove 10b is provided in the side face of the cylindrical base portion 10a. On the other hand, in the example shown in FIG. 9, a plurality of linear grooves 10c are provided, which are arranged to be spaced away from each other along the circumferential direction and extend along the axial direction. By providing such grooves 10b, 10c, the matters removed from the wafer W can be guided along the spiral or linear grooves 10b, 10c and excluded outside. In this way, the contact pressure of the periphery cleaning member 10 against the wafer W can be changed, thereby to readily and efficiently remove the matters attached to the periphery of the wafer W.

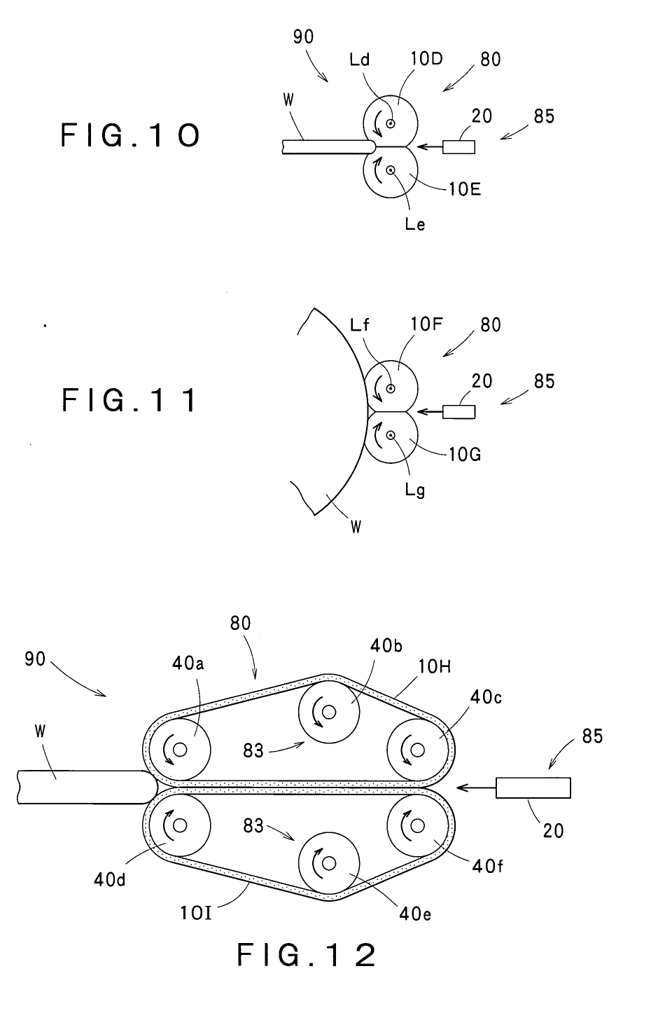

Furthermore, in the embodiment described above, a case in which the first cleaner 80 is configured such that each periphery cleaning member 10 having a substantially cylindrical shape is driven alone to contact with a wafer W has been discussed. The first cleaner 80 may be however configured to include a pair of periphery cleaning members, as shown in FIGS. 10 and 11, wherein the periphery cleaning members are arranged to be pressed against each other and can be rotated in reverse directions, respectively.

In the example shown in FIG. 10, the first cleaner 80 includes a first cleaning member (upper cleaning member) 10D adapted to contact with the periphery of a wafer W from its one side (for example, the front face (top face)) and a second cleaning member (lower cleaning member) 10E adapted to contact with the periphery of the wafer W from the other side thereof (for example, the rear face (bottom face)). In other words, the pair of periphery cleaning members 10D, 10E are configured to contact with a wafer W from its different sides, respectively. Namely, the pair of periphery cleaning members 10D, 10E are arranged such that each rotation axis Ld, Le of the pair of periphery cleaning members 10D, 10E becomes orthogonal to a perpendicular line drawn to the substrate face of the wafer W to be cleaned. Contrary, in the example shown in FIG. 11, a pair of periphery cleaning members 10F, 10G are configured to contact with a wafer W, wherein each rotation axis Lf, Lg of the pair of periphery cleaning members 10F, 10G becomes parallel to the perpendicular line drawn to the substrate face of the wafer W to be cleaned.

In the example shown in FIGS. 10 and 11, the nozzle 20 of the second cleaner 85 is located in a position opposed to the wafer W across the pair of periphery cleaning members 10C and 10D or 10E and 10F, and the nozzle 20 of the second cleaner 85 is arranged such that it jet a cleaning liquid toward a portion at which the pair of periphery cleaning members 10C and 10D or 10E and 10F are rotated away from each other.

By forming the first cleaner 80 with the pair of periphery cleaning members 10C and 10D or 10E and 10F such that they contact with the periphery of the wafer W and contact with each other and they are rotated in opposite directions, respectively, the contact area between the wafer W and the first cleaner 80 can be significantly increased. Consequently, the matters attached to the wafer W can be removed efficiently and securely, thus enhancing the cleaning efficiency and improving the cleaning accuracy. Due to the configuration such that the pair of periphery cleaning members 10C and 10D or 10F and 10G are pressed together and compressed against each other, the attached and removed mutters presented in the periphery cleaning members can be excluded outside. Further, such matters excluded onto the outer surface of each periphery cleaning member can be washed away due to the cleaning liquid jetted from the nozzle 20.

Furthermore, in the embodiment described above, while an example in which each periphery cleaning member 10 has a substantially cylindrical contour has been discussed, the shape of the periphery cleaning member 10 is not limited to this aspect. For example, as shown in FIG. 12, each periphery cleaning member 10 may be configured to be rotated (turned or circulated) on a preset track and may be formed of a flexible endless belt. In the example shown in FIG. 12, the first cleaner 80 can include a first cleaning belt (upper cleaning belt) 10H provided across a plurality of, for example, three, rotating rollers 40a, 40b, 40c and a second cleaning belt (lower cleaning belt) 10I provided across a plurality of, for example, three, rotating rollers 40d, 40e, 40f. The first cleaning belt 10H is configured to contact with the front face (top face), for example, of the periphery of a wafer W, while the second cleaning belt 10I is configured to contact with the rear face (bottom face), for example, of the wafer W. Also, the first cleaning belt 10H and the second cleaning belt 10I are configured to contact with each other and rotate in opposite directions, respectively. Specifically, in FIG. 12, the first cleaning belt 10H is rotated in the counter-clockwise direction, while the second cleaning belt 10I is rotated in the clockwise direction. In this example, either one of the three rollers 40a, 40b, 40c which are engaged with the first cleaning belt 10H as well as either one of the three rollers 40d, 40e, 40f which are engaged with the second cleaning belt 10I are connected with rotating motors (not shown), respectively, so as to drive and rotate the first cleaning belt 10H and the second cleaning belt 10I. Namely, in this example, the rotation drive section 83 is composed of the rotating motors (not shown) and rotating rollers 40a, 40b, 40c, 40d, 40e, 40f.

The nozzle 20 of the second cleaner 85 is located in a position opposed to the wafer W across the first cleaning belt 10H and the second cleaning belt 10I and is arranged to jet a cleaning liquid toward a point at which the first cleaning belt 10H and the second cleaning belt 10I once contacted together are rotated away from each other.

In the example shown in FIG. 12, the contact area between the wafer W and the first cleaner 80 can be increased. Accordingly, the matters attached to the wafer W can be removed efficiently and securely, as such enhancing the cleaning efficiency and improving the cleaning accuracy. Additionally, the nozzle 20 of the second cleaner 85 can be located in a position that is relatively far from the wafer W. Consequently, the matters attached to the periphery cleaning members can be removed more securely.

Furthermore, in the embodiment described above, while an example in which the pressing mechanism 82 of the first cleaner 80 includes the press spring 33 and the pressure sensor 34 which are arranged on both sides of the swaying arm 32 pivotally secured to the movable arm 31 has been discussed, the configuration of the pressing mechanism 82 is not limited to this aspect.

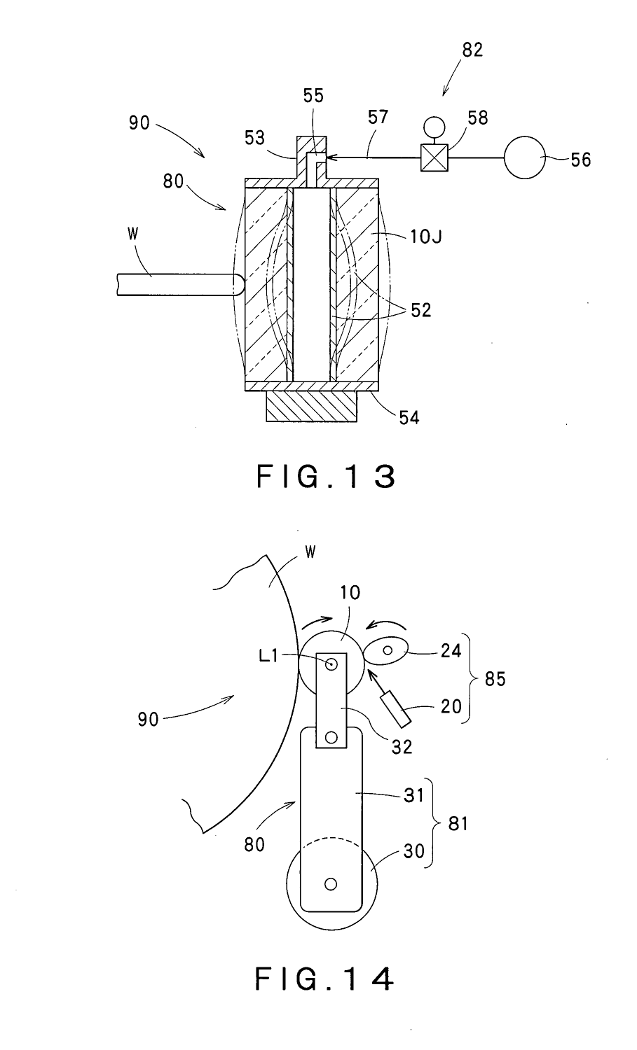

In an example shown in FIG. 13, each periphery cleaning member 10J is formed of a flexible porous material, such as sponge, and has a substantially cylindrical contour. The first cleaner 80 further includes a first holding member (upper holding member) 53 and a second holding member (lower holding member) 54, which are attached to either ends (e.g., the top end and the bottom end) of the periphery cleaning member 10J, respectively. In the first holding member 53, a communication hole 55 is formed to provide communication with the interior of the substantially cylindrical periphery cleaning member 10J.

The pressing mechanism 82 of this example, includes a flexible tube 52 arranged inside the periphery cleaning member 10J, and a fluid supply source 56 which supplies a fluid into the flexible tube 52. The fluid supply source 56 is configured to supply a pressurized fluid, for example, pure water, into the flexible tube 52 via the communication hole 55 provided in the first holding member 53. Also, as shown in FIG. 13, a flow rate control valve 58 is provided in the course of a supply tube 57 which connects the fluid supply source 56 with the communication hole 55. In the pressing mechanism 82 of such configuration, dilation of the flexible tube 52 due to supply of a fluid from the fluid supply source 56 into the flexible tube 52 causes the periphery cleaning member 10J to be pushed outward, thereby pressing the periphery cleaning member 10J against the wafer W. Further, according to the pressing mechanism of this example, the flow rate of the fluid to be supplied can be adjusted by the flow rate control valve 58, thus controlling the contact pressure against the wafer W.

In the embodiment described above, while an example in which the second cleaner 85 includes the nozzle 20 adapted to inject a cleaning liquid toward each periphery cleaning member has been discussed, the configuration of the second cleaner is not limited to such an aspect. For example, as shown in FIG. 14, the second cleaner 85 may further includes a cam 24 which is adapted to press the periphery cleaning member. In the example shown in FIG. 14, the cam 24 is located in a position opposed to the wafer W across the periphery cleaning member 10 so as to press a portion of the periphery cleaning member 10 on the opposite side of its contact portion to the wafer W. The cam 24 is configured as an eccentric cam, for example, and is adapted to intermittently compress the rotating periphery cleaning member 10. According to such a second cleaner 85, by compressing the periphery cleaning member 10 due to the cam 24, the attached and transferred matters present in the periphery cleaning member 10 can be excluded outside. Further, such matters excluded onto the outer surface of the periphery cleaning member can be washed away due to the cleaning liquid jetted from the nozzle 20.

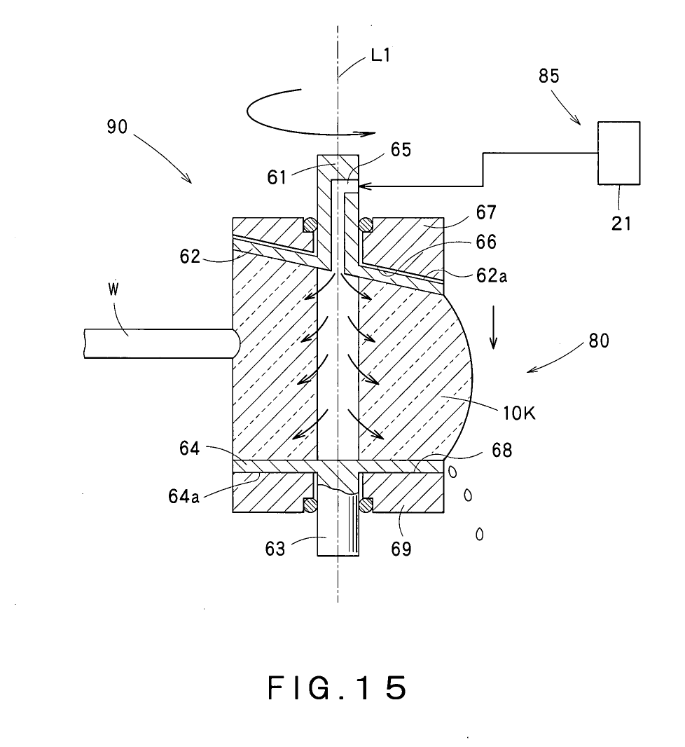

Further modifications of the first cleaner 80 and the second cleaner 85 will now be described below. FIG. 15 is a schematic cross section showing still another variation for the first cleaner 80 and the second cleaner 85.

In the example shown in FIG. 15, the first cleaner 80 is formed of a flexible porous material, such as sponge, and includes a periphery cleaning member 10K having a substantially cylindrical contour, a first rotatable disk (upper rotatable disk) 62 and a second rotatable disk (lower rotatable disk) 64, which are adapted to support the periphery cleaning member 10K on either side (for example, both on the upper and lower sides). Further, the first rotatable disk 62 and second rotatable disk 64 include shaft members 61, 63, respectively, each of the shaft members functioning as a rotating shaft adapted to rotate the periphery cleaning member 10K. Either one of the two shaft members 61, 63 is connected with the aforementioned rotating motor 15 (see FIG. 5).

As shown in FIG. 15, in the shaft member 61 of the first rotatable disk 62, a communication hole 65 is formed to provide communication with the interior of the substantially cylindrical periphery cleaning member 10K. The second cleaner 85 of this example further includes a cleaning liquid supply source 21 which supplies a cleaning liquid into the periphery cleaning member 10K via the communication hole 65. According to this variation of such configuration, by supplying a cleaning liquid from the cleaning liquid supply source 21 into the periphery cleaning member 10K formed of a porous material, the matters present in the periphery cleaning member 10K can be washed away to the outside, due to the cleaning liquid which flows out of the periphery cleaning member 10K.

In addition, as shown in FIG. 15, the first cleaner 80 further includes a first guide disk (upper guide disk) 67 adapted to engage with the first rotatable disk 62 from above, for example, and a second guide disk (lower guide disk) 69 adapted to engage with the second rotatable disk 64 from below, for example. The first guide disk 67 and second guide disk 69 have holes through which the shaft members 61, 63 of the first rotatable disk 62 and second rotatable disk 64 extend, respectively, so as to rotatably support the first rotatable disk 62 and second rotatable disk 64 about the rotation axis L1. The first guide disk 67 and second guide disk 69 are configured such that their movement in the direction orthogonal to the rotation axis L1 of the first rotatable disk 62 and second rotatable disk 64 can be controlled, respectively.

Also, as shown in FIG. 15, it is preferred that the periphery cleaning member 10K is compressed intermittently with its rotation, due to each engagement of the first rotatable disk 62 and second rotatable disk 64, between which the periphery cleaning member 10K is supported, with the first guide disk 67 and second guide disk 69, respectively. In the example shown in FIG. 15, an engagement face 66 of the first guide disk 67, which faces the first rotatable disk 62, is inclined relative to the rotation axis L1 such that the distance between the face 66 and the second guide disk 69 is gradually decreased toward one side. Similarly, an engagement face 62a of the first rotatable disk 62, which faces the first guide disk 67, is inclined relative to the rotation axis L1 such that the distance between the face 62a and the second rotatable disk 64 is gradually decreased toward the one side. Contrary, engagement faces 64a, 68 of the second rotatable disk 64 and second guide disk 69, which face each other, are formed as flat faces extending in the direction orthogonal to the rotary axis L1, respectively.

In this example of such configuration, when the first rotatable disk 62 and second rotatable disk 64 as well as the periphery cleaning member 10K interposed therebetween are rotated due to drive by means of the rotating motor 15 (not shown), the first rotatable disk 62 slides on the periphery cleaning member 10K while repeating separation and approach relative to the first guide disk 67, due to the engagement between the first rotatable disk 62 and the first guide disk 67. Thus, the periphery cleaning member 10K repeats to take a compressed position and a non-compressed position, with its rotation, as such the matters once attached to the wafer W and now present in the periphery cleaning member 10K can be excluded outside. In this case, as described above, the matters present in the periphery cleaning member 10K can also be washed away to the outside, due to the cleaning liquid which comes in and then flows out of the periphery cleaning member 10K. Accordingly, the matters can be removed from the periphery cleaning member 10K more efficiently and securely.

In the modification shown in FIG. 15, while an example in which the engagement face 62a of the first rotatable disk 62 and the engagement face 66 of the first guide disk 67 are inclined has been described, the configuration is not limited to this aspect. Instead, the engagement face 64a of the second rotatable disk 64 and the engagement face 68 of the second guide disk 69 may be inclined. Alternatively, the engagement face 62a of the first rotatable disk 62 and the engagement face 66 of the first guide disk 67 as well as the engagement face 64a of the second rotatable disk 64 and the engagement face 68 of the second guide disk 69 may be inclined.

In the embodiment described above, a method of cleaning the surface and periphery of a wafer W has been discussed, which comprises a first step of supplying a chemical liquid onto the surface of the wafer W, and a second step of cleaning the periphery of the wafer W by using each periphery cleaning member 10 while supplying pure water onto the surface of the wafer W, with the periphery cleaning member 10 being cleaned by using the second cleaner 85. However, various modifications may be applied to such a method of cleaning the wafer W. For example, also in the first step, the periphery of the wafer W may be cleaned by using each periphery cleaning member 10 while cleaning the periphery cleaning member 10 by using the second cleaner 85. Alternatively, a step of supplying pure water onto the wafer W while the periphery cleaning member 10 has been returned to the waiting position may be further added. Additionally, as shown by two-dot chain lines in FIG. 1, a periphery cleaning liquid supply nozzle 75, which is adapted to supply a cleaning liquid to the periphery of the wafer W, may be provided separately from the cleaning liquid supply nozzle 5, so as to clean the surface of the wafer W and the periphery of the wafer W in separate steps. Two specific modifications of the cleaning method will now be described below.

First, a first modification comprising first to third cleaning steps will be described. In the first step of this example, a chemical liquid is supplied to approximately the center of the surface of a wafer W from the cleaning liquid supply nozzle 5, so as to clean the surface of the wafer W due to the chemical liquid. Also, in the first step, each periphery cleaning member 10 is located in its cleaning position, and the periphery of the wafer W is cleaned by the periphery cleaning member 10. During this operation, each periphery cleaning member 10 is cleaned by the second cleaner 85. In the second step, the supply of the chemical liquid from the cleaning liquid supply nozzle 5 is stopped, and instead pure water is supplied from the cleaning liquid supply nozzle 5, so as to rinse the surface of the wafer W. In the second step, each periphery cleaning member 10 is still located in the cleaning position, and the periphery of the wafer W is cleaned by the periphery cleaning member 10. During this operation the periphery cleaning member 10 is cleaned by the second cleaner 85. Thereafter, in the third step, each periphery cleaning member 10 is returned to the waiting position. Meanwhile, the supply of pure water from the cleaning liquid supply nozzle 5 is continued, and the rinsing is completed in this step.

Next, a second modification comprising first to fifth cleaning steps will be described. The second modification is carried out by using the substrate cleaning apparatus 10 including a periphery cleaning liquid supply nozzle 75 which is shown by two-dot chain lines in FIG. 1. The periphery cleaning liquid supply nozzle 75 is switchably connected with a chemical liquid supply source 87 and a pure water supply source 79 via a supply tube 77 in the course of which a switching valve 76 is provided, so as to supply a chemical liquid or pure water as a rinsing liquid from the center of a wafer W to its periphery.

Specifically, as the first step of the second modification of the cleaning method, a chemical liquid is supplied to approximately the center of surface of a wafer W from the cleaning liquid supply nozzle 5, so as to clean the surface of the wafer W due to the chemical liquid. In the first step, each periphery cleaning member 10 is located in the waiting position. Next, as the second step, the supply of the chemical liquid from the cleaning liquid supply nozzle 5 is stopped, and instead pure water is supplied from the cleaning liquid supply nozzle 5, so as to rinse the surface of the wafer W. Also, in the second step, each periphery cleaning member 10 is still remained in the waiting position. In such a way, in the first and second steps, the surface of the wafer W is cleaned using a chemical liquid as well as rinsed with pure water.

Subsequently, as the third step, a chemical liquid is supplied to the periphery of the wafer W from the periphery cleaning liquid supply nozzle 75, so as to clean the periphery of the wafer W due to the chemical liquid. In this step, each periphery cleaning member 10 is located in its cleaning position. Namely, the periphery of the wafer W is also cleaned due to contact with each periphery cleaning member 10, with the periphery cleaning member 10 being cleaned by the second cleaner 85. Next, in the fourth step, the supply of the chemical liquid from the periphery cleaning liquid supply nozzle 75 is stopped, and instead pure water is supplied from the periphery cleaning liquid supply nozzle 75, so as to rinse the surface of the wafer W. Also, in the fourth step, each periphery cleaning member 10 is still remained in the cleaning position. In such a manner, in the third and fourth steps, the periphery of the wafer W is cleaned using a chemical liquid as well as rinsed with pure water, with each periphery cleaning member 10 being located in the cleaning position. In this case, the supply of pure water from the cleaning liquid supply nozzle 5 is continued, starting from the second step and also during the third and fourth steps. The pure water supplied from the cleaning liquid supply nozzle 5 flows on the wafer W, which is rotated, from approximately the center to the periphery of the wafer W. Accordingly, the cleaning liquid supplied from the periphery cleaning liquid supply nozzle 75 can not flow toward the center of the wafer W during the third and fourth steps.

Thereafter, as the fifth step, each periphery cleaning member 10 is returned to its waiting position. Meanwhile, the supply of pure water from the cleaning liquid supply nozzle 5 and the periphery cleaning liquid supply nozzle 75 is continued, and the rinsing for the surface and periphery of the wafer W is completed in this step.

1. A substrate cleaning method for cleaning a periphery of a substrate to be processed, comprising the steps of:
cleaning the periphery of the substrate by contacting a periphery cleaning member with the periphery of the substrate; and
removing matters from the periphery cleaning member, the matters once attached to the substrate and then transferred therefrom and attached to the periphery cleaning member;
wherein the step of cleaning the periphery using the periphery cleaning member and the step of removing the attached matters from the periphery cleaning member are performed at the same time.

2. The substrate cleaning method according to claim 1, wherein the periphery cleaning member, which is in contact with the substrate, is pressed against the substrate.

3. The substrate cleaning method according to claim 2, wherein the periphery cleaning member is pressed against the substrate, by supplying a fluid into a flexible tube disposed in the periphery cleaning member so as to dilate the flexible tube.

4. The substrate cleaning method according to claim 1, wherein the substrate and the periphery cleaning member are rotated such that their respective portions which are in contact with each other are moved in opposite directions at a point where the substrate and the periphery cleaning member contact with each other.

5. The substrate cleaning method according to claim 1, wherein the periphery cleaning member, which is in contact with the substrate, is shifted in the substantially orthogonal direction relative to a plate surface of the substrate.

6. The substrate cleaning method according to claim 1, wherein two periphery cleaning members are driven to be in contact with the peripheral of the substrate at opposite portions of the peripheral, respectively.

7. The substrate cleaning method according to claim 1, wherein a pair of periphery cleaning members arranged to be in contact with each other are driven to be in contact with the substrate while being rotated in reverse directions, respectively.

8. The substrate cleaning method according to claim 7, wherein the pair of periphery cleaning members are driven to be in contact with the substrate such that each rotation axis of the pair of periphery cleaning members and the perpendicular line drawn to a plate surface of the substrate are parallel to one another.

9. The substrate cleaning method according to claim 1, wherein the attached matters are removed from the periphery cleaning member by jetting a cleaning liquid toward the periphery cleaning member.

10. The substrate cleaning method according to claim 1, wherein the attached matters are removed from the periphery cleaning member by compressing the periphery cleaning member as well as by jetting a cleaning liquid toward the periphery cleaning member.

11. The substrate cleaning method according to claim 1, wherein the attached matters are removed from the periphery cleaning member by supplying a cleaning liquid into the periphery cleaning member formed of a porous material and then causing the cleaning liquid to flow out of the periphery cleaning member.

12. The substrate cleaning method according to claim 11, wherein the periphery cleaning member is compressed intermittently with its rotation.

13. A substrate cleaning apparatus for cleaning a periphery of a substrate to be processed, comprising:
a first cleaner including a rotatable periphery cleaning member which is adapted to be in contact with the periphery of the substrate and remove matters attached to the substrate from its periphery; and
a second cleaner which is configured to remove the matters, once attached to the substrate and then transferred from the substrate to the periphery cleaning member, from the periphery cleaning member while removing the matters attached to the substrate by using the first cleaner.

14. The substrate cleaning apparatus according to claim 13, wherein the first cleaner further includes a pressing mechanism adapted to press the periphery cleaning member against the substrate.

15. The substrate cleaning apparatus according to claim 14, wherein the pressing mechanism includes a flexible tube disposed in the periphery cleaning member and a fluid supply source for supplying a fluid into the flexible tube.

16. The substrate cleaning apparatus according to claim 13, wherein the first cleaner further includes a shifting mechanism adapted to shift the periphery cleaning member, which is in contact with the substrate, in the direction along the rotation axis of the periphery cleaning member, relative to the substrate.

17. The substrate cleaning apparatus according to claim 13, wherein the first cleaner includes two periphery cleaning members adapted to be in contact with the peripheral of the substrate at opposite portions of the peripheral, respectively.

18. The substrate cleaning apparatus according to claim 13, wherein the first cleaner includes a pair of periphery cleaning members which are arranged to be in contact with each other and rotatable in reverse directions relative to each other.

19. The substrate cleaning apparatus according to claim 18, wherein the pair of periphery cleaning members are configured to be in contact with the substrate such that each rotation axis of the pair of periphery cleaning members and the perpendicular line drawn to a plate surface of the substrate are parallel to one another.

20. The substrate cleaning apparatus according to claim 13, wherein the second cleaner includes a nozzle adapted to jet a cleaning liquid toward the periphery cleaning member.

21. The substrate cleaning apparatus according to claim 20, wherein the second cleaner includes a cam adapted to press the periphery cleaning member.

22. The substrate cleaning apparatus according to claim 13, wherein the periphery cleaning member is formed of a porous material, and the second cleaner includes a cleaning liquid supply source for supplying a cleaning liquid into the periphery cleaning member formed of the porous material.

23. The substrate cleaning apparatus according to claim 22, wherein the periphery cleaning member formed of the porous material is configured to be compressed intermittently with its rotation.
